(19) United States
(12) Patent Application Publication
(10) Pub. No.: US 2026/0166991 A1
(43) Pub. Date: Jun. 18, 2026

(54) VIRTUAL ENVIRONMENT CONTENT MANAGEMENT APPARATUS AND METHOD

(71) Applicants: HYUNDAI MOTOR COMPANY, Seoul (KR); KIA CORPORATION, Seoul (KR)

(72) Inventors: Ki Chang Kim, Hwaseong-si (KR); Dong Chul Park, Hwaseong-si (KR)

(73) Assignees: HYUNDAI MOTOR COMPANY, Seoul (KR); KIA CORPORATION, Seoul (KR)

(21) Appl. No.: 19/232,534

(22) Filed: Jun. 9, 2025

(30) Foreign Application Priority Data
Dec. 13, 2024 (KR) 10-2024-0186016

(51) Int. Cl. B60K 35/21; B60K 35/25; G06T 7/90; G10L 15/18

(52) U.S. Cl. CPC B60K 35/211; B60K 35/25; G06T 7/90; G10L 15/1815

(57) ABSTRACT

A virtual environment content management apparatus includes a communication unit, one or more processors, and a memory. The communication unit receives vehicle driving information and occupant detection information from a sensor unit of a vehicle and receives sound source usage information from a user terminal. The memory stores computer-executable instructions. The one or more processors execute the computer-executable instructions to implement a first, second, third, and fourth processing unit. The first processing unit analyzes image information of virtual environment content. The second processing unit generates a sound signal based on the image information, the sound source usage information, the vehicle driving information, and the occupant detection information. The third processing unit generates a vibration signal corresponding to the sound signal based on the image information and the occupant detection information. The fourth processing unit reconstructs the virtual environment content based on the sound signal and the vibration signal.

### CROSS-REFERENCE TO RELATED APPLICATION

This application claims priority to and the benefit of Korean Patent Application No. 10-2024-0186016 filed in the Korean Intellectual Property Office on Dec. 13, 2024, the entire disclosure of which is incorporated herein by reference.

### BACKGROUND

### 1. Field of the Disclosure

The present disclosure relates to a virtual environment content management apparatus and method.

### 2. Discussion of Related Art

Recently, consumption patterns in the Emotional Information & Communication Technology (ICT) field, which detects and recognizes a user's emotions and provides services using Information Technology (IT) devices, have increased. In addition, the market for content that can be experienced in a vehicle is rapidly expanding due to technological advancements and the spread of autonomous vehicles.

Additionally, advancements in technology allows an occupant to wear a virtual environment device (a VR device) to play games or watch movies inside autonomous vehicles. However, virtual environment devices commonly used today only have a function of outputting a preset sound without considering a vehicle driving environment or a state of the occupant, which may hinder the immersion of the occupant.

### SUMMARY OF THE DISCLOSURE

The present disclosure is directed to providing a virtual environment content management apparatus that generates virtual content that improves the immersion experience of a vehicle occupant in a virtual environment.

In particular, the present disclosure integrates various pieces of hardware and software to enrich the experience of the occupant while the vehicle is moving. In addition, the present disclosure enables the use of vibration functions built into a vehicle seat to further improve the virtual environment content.

According to an aspect of the present disclosure, a virtual environment content management apparatus includes a communication unit, one or more processors, and a non-transitory memory. The communication unit is configured to receive vehicle driving information and occupant detection information from a sensor unit of a vehicle and sound source usage information from a user terminal. The non-transitory memory is configured to store computer-executable instructions. The processor is configured to execute the computer-executable instructions to implement a first, second, third, and fourth processing unit. The first processing unit analyzes image information of virtual environment content. The second processing unit generates a sound signal based on the image information, the sound source usage information, the vehicle driving information, and the occupant detection information. The third processing unit generates a vibration signal corresponding to the sound signal based on the image information and the occupant detection information. The fourth processing unit reconstructs the virtual environment content based on the sound signal and the vibration signal.

The second processing unit may set the sound signal as one of an entertainment type, a sandbox type, and a professional type based on the sound source usage information.

The second processing unit may extract emotional adjectives based on the sound source usage information and quantify contribution of the emotional adjectives to set the sound signal as one of an entertainment type, a sandbox type, and a professional type.

The second processing unit may set voice parameters corresponding to image parameters constituting the image information and generate the sound signal based on the voice parameters.

The second processing unit may extract the image parameters including impact intensity, color, brightness, and contact time, and set the image parameters as the voice parameters including volume, timbre, pitch, and duration.

The second processing unit may adjust volume, timbre, and sound spatial information of the sound signal based on an accelerator pedal response and a vehicle speed.

The third processing unit may set a pattern of the vibration signal based on a background sound and a sound effect of the sound signal.

The third processing unit may analyze emotional information of an occupant based on seating information of the occupant included in the occupant detection information and set a pattern of the vibration signal based on the emotional information.

The third processing unit may analyze action information of the image information to set a pattern of the vibration signal.

The fourth processing unit may generate a reproduction signal obtained by synchronizing the sound signal and the vibration signal with the image information of the virtual environment content.

According to another aspect of the present disclosure, a virtual environment content management method includes receiving, by a communication unit, vehicle driving information and occupant detection information from a sensor unit of a vehicle and receiving, by the communication unit, sound source usage information from a user terminal. The method further includes analyzing, by the processor, image information of virtual environment content. The method also includes generating, by the processor, a sound signal based on the image information, the sound source usage information, the vehicle driving information, and the occupant detection information. The method further includes generating, by the processor, a vibration signal corresponding to the sound signal based on the image information and the occupant detection information. The method also includes reconstructing, by the processor, the virtual environment content based on the sound signal and the vibration signal.

The generating of the sound signal may include setting, by the processor, the sound signal as one of an entertainment type, a sandbox type, and a professional type based on the sound source usage information.

The generating of the sound signal may include extracting, by the processor, emotional adjectives based on the sound source usage information, and quantifying, by the processor, contribution of the emotional adjectives to set the sound signal as one of an entertainment type, a sandbox type, and a professional type.

The generating of the sound signal may include setting, by the processor, voice parameters corresponding to image parameters constituting the image information and generating, by the processor, the sound signal according to the voice parameters.

The generating of the sound signal may include extracting, by the processor, the image parameters including impact intensity, color, brightness, and contact time, and setting, by the processor, the image parameters as the voice parameters including volume, timbre, pitch, and duration.

The generating of the sound signal may include adjusting, by the processor, volume, timbre, and sound spatial information of the sound signal based on an accelerator pedal response and a vehicle speed.

The generating of the sound signal may include setting, by the processor, a pattern of the vibration signal based on a background sound and a sound effect of the sound signal.

The generating of the sound signal may include analyzing, by the processor, emotional information of an occupant based on seating information of the occupant included in the occupant detection information, and setting, by the processor, a pattern of the vibration signal based on the emotional information.

The generating of the sound signal may include analyzing, by the processor, action information of the image information to set a pattern of the vibration signal.

The reconstructing of the virtual environment content may include generating, by the processor, a reproduction signal obtained by synchronizing the sound signal and the vibration signal with the image information of the virtual environment content.

### BRIEF DESCRIPTION OF THE DRAWINGS

The above and other objects, features and advantages of the present disclosure should become more apparent to those of ordinary skill in the art by describing various embodiments thereof in detail with reference to the accompanying drawings, in which:

FIG. 1 is a diagram showing modules constituting a vehicle according to an embodiment of the present disclosure;

FIG. 2 is a diagram depicting the operating environment of a virtual environment content management apparatus according to an embodiment of the present disclosure;

FIGS. 3 and 4 are diagrams depicting the virtual environment content according to an embodiment of the present disclosure;

FIG. 5 is a diagram depicting the operation of a vibrator according to an embodiment of the present disclosure;

FIG. 6 is a block diagram of the virtual environment content management apparatus according to an embodiment of the present disclosure;

FIG. 7 is a diagram depicting the operation of the virtual environment content management apparatus according to an embodiment of the present disclosure; and

FIG. 8 is a flowchart of a virtual environment content management method according to an embodiment of the present disclosure.

### DETAILED DESCRIPTION

Various embodiments of the present disclosure are described below in detail with reference to the accompanying drawings.

However, the technical spirit of the present disclosure is not limited to the described embodiments but may be implemented in various different forms. One or more of the components among the embodiments may be used by being selectively coupled or substituted without departing from the scope of the technical spirit of the present disclosure.

In addition, terms (including technical and scientific terms) used in various embodiments of the present disclosure may be interpreted as meanings that are generally understood by those of ordinary skill in the art to which the present disclosure pertains unless explicitly specifically defined and described. The meanings of the commonly used terms, such as terms defined in a dictionary may be interpreted in consideration of their contextual meanings in the related art.

In addition, the terms used in the embodiments of the present disclosure are for describing the embodiments and are not intended to limit the present disclosure.

In the specification, the singular forms may include a plural form unless the context clearly dictates otherwise. When described as “at least one (or one or more) of A, B, and C,” the embodiment may include one or more of all possible combinations of A, B, and C.

In addition, terms such as first, second, A, B, (a), and (b) may be used to describe components of the embodiments of the present disclosure.

These terms are intended only for distinguishing one component from another component. The nature, sequence, order, and the like of the components are not limited by these terms.

In addition, when a first component is described as being “connected,” “coupled,” or “joined” to a second component, the first component should be considered as not only being directly connected, coupled, or joined to the second component, but also as being “connected,” “coupled,” or “joined” to the second component with still another component disposed between the first component and the second component.

In addition, when a first component is described as being formed or disposed on “on (above) or below (under)” a second component, “on (above)” or “below (under)”, the first component should be considered as including not only a case in which two components are in direct contact with each other, but also a case in which one or more other components are formed or disposed between the two components. In addition, when expressed as “on (above) or below (under),” it may include the meaning of not only an upward direction but also a downward direction based on one component.

When a component, device, element, or the like of the present disclosure is described as having a purpose or performing an operation, function, or the like, the component, device, or element should be considered herein as being “configured to” meet that purpose or to perform that operation or function. Each component, device, element, apparatus, and the like may separately embody or be included with a processor and a memory, such as a non-transitory computer readable media, as part of the apparatus. The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in combination thereof.

Various embodiments are described below in detail with reference to the accompanying drawings. However, the same or corresponding components are denoted by the same reference numeral regardless of the reference numerals and overlapping descriptions thereof are omitted.

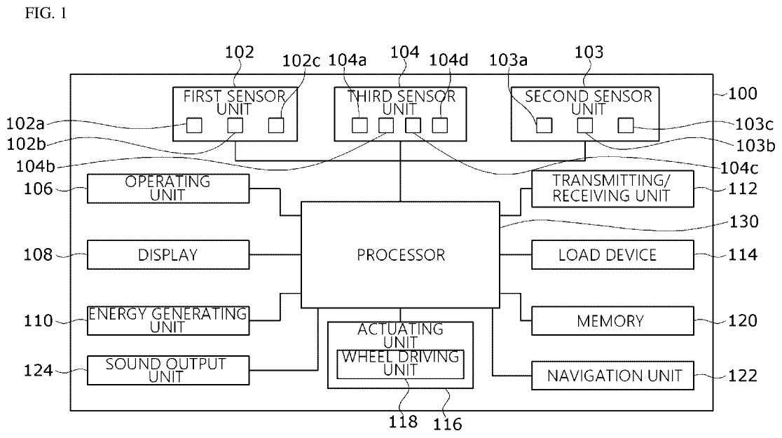

FIG. 1 is a diagram showing modules constituting a vehicle according to an embodiment of the present disclosure.

A vehicle 100 may include sensor units 102, 103, and 104, an operation or operating unit 106, a display 108, a load device 114, and a transceiver, e.g., a transmitting/receiving unit, 112.

The sensor unit 102 may be equipped with various types of detectors for detecting various states and situations occurring in an external environment, an internal system, a user operation, and a boarding space of the vehicle 100.

Specifically, a first sensor unit 102 may be equipped with an externally oriented camera 102a, a LiDAR sensor 102b, a radar sensor 102c, and the like, to recognize dynamic and static objects present outside the vehicle 100. The camera 102a may recognize an external object as an image while the vehicle 100 is in use, generate image data, and transmit the image data to a processor 130. The LiDAR sensor 102b may generate point cloud data as recognized data of the external object and transmit the point cloud data to the processor 130 to generate 3D spatial information that identifies at least a shape of the external object. The radar sensor 102c may emit radio waves of a specific frequency around the vehicle 100 and generate radar data through the radio waves reflected from the external object to check the presence of the external object, and its relative distance, speed, direction, and the like. In an embodiment, the first sensor unit 102 includes a LiDAR sensor 102b. However, in other embodiments, the LiDAR sensor 102b may not be mounted or included in or on the vehicle.

The first sensor unit 102 may generate object recognition information based on sensing data. The object recognition information may include information on the presence of an object, information on the position of the object, information on the distance between the vehicle 100 and the object, and information on the relative speed between the vehicle 100 and the object. In an embodiment, the external object may be one of various objects related to the driving of the vehicle 100.

A second sensor unit 103 may be equipped with a positioning sensor 103a, a wheel sensor 103b, and an altitude sensor 103c to check the position, speed, and driving altitude of a host vehicle. The positioning sensor 103a may include a gyro sensor, an angular velocity sensor, an acceleration sensor, and the like. The altitude sensor may be an inertial measurement unit (IMU) sensor and may be equipped with a 3-axis accelerometer and a 3-axis gyroscope. The altitude sensor may measure acceleration in a traveling direction x, acceleration in a lateral direction y, and acceleration in a height direction z of the vehicle 100, and the yaw, pitch, and roll as the angular velocity of the vehicle.

The second sensor unit 103 may generate vehicle driving information based on sensing data. The vehicle driving information may be information generated based on data detected by various sensors installed inside the vehicle 100. For example, the vehicle driving information may include vehicle altitude information, vehicle speed information, vehicle inclination information, vehicle weight information, vehicle direction information, vehicle battery information, vehicle fuel information, vehicle tire air pressure information, vehicle steering information, vehicle interior temperature information, vehicle interior humidity information, pedal position information, vehicle engine temperature information, and the like.

Additionally, the vehicle driving information may include route information. The route information may refer to information generated based on a destination input by a vehicle user through the operation unit 106. The route information may refer to information that indicates a traveling route from a current position of the host vehicle to a destination on map when the destination has been set. When no destination is set, the route information may refer to information including a road on which the host vehicle is currently traveling and a future driving route including the road.

A third sensor unit 104 may include a voice sensor 104a that collects voice signals inside the vehicle 100, a vibration sensor 104b disposed around an occupant, a camera 104c that captures an image of the inside of the vehicle 100, and a pressure sensor 104d.

The voice sensor 104a may include at least one microphone disposed inside the vehicle 100. The voice sensor 104a collects voices and humming sounds expressed by the occupant inside the vehicle 100 to generate an audio signal.

The vibration sensor 104b may include at least one acceleration sensor or gyro sensor disposed at a location where the body of the occupant may touch various components of the vehicle. The vibration sensor 104b may generate a vibration signal by measuring the vibrations occurring when the occupant taps a steering wheel, a console box, or a dashboard inside the vehicle 100.

The camera 104c may capture an image of the inside of the vehicle 100 and may be disposed to face the front side of the upper body of the occupant, thereby generating a video signal obtained by capturing images of the movements of the occupant.

The pressure sensor 104d may be disposed in a vehicle seat 20 and detects the pressure applied to the vehicle seat 20. A plurality of pressure sensors 104d may be disposed on a backrest and a bottom of the vehicle seat 20. The pressure sensor 104d may convert the pressure applied to the vehicle seat 20 into an electrical signal to generate a pressure signal.

The operation unit 106 may be formed as a module for the user to control driving. For example, the operation unit 106 may include a steering wheel for manual driving, an automatic or manual shift transmission, an accelerator pedal, a brake pedal, and the like. The operation unit 106 may further include an interface for enabling or disabling an autonomous driving mode and selecting detailed functions requested by the user so that the user may use an autonomous driving function. The operation unit 106 may be implemented as, for example, a hard type interface provided at a predetermined location inside the vehicle 100, or a soft type interface through which the display 108 may be touched to receive various requests related to autonomous driving. Depending on the specifications of the autonomous vehicle, at least one of the steering wheel, the transmission, and the pedal may be omitted. In another example, the operation unit 106 may be equipped with a module for receiving a user's control request for the load device 114 in addition to driving control.

The display 108 may include a user interface. The processor 130 may cause the display 108 to display information such as the operating state, the control state, the route/traffic information, the remaining energy information of the vehicle 100, and the content requested by a driver. Additionally, the display 108 may be implemented as a touch screen capable of detecting a driver's input and receiving a request from the driver to instruct the processor 130.

In an embodiment, the load device 114 may be mounted on the vehicle 100 and may be a type of non-driving electric device excluding a driving power system such as a wheel driving unit 118. In an embodiment, the load device 114 may be an auxiliary device that receives electric power from an energy generating unit 110, and may include, for example, an air conditioning system, a lighting system, a seat system, various devices installed in the vehicle 100, and the like. In the present disclosure, the vehicle 100 may further include a cooling/heating system that cools or heats at least one of a battery, a fuel cell, an internal combustion engine, an air conditioning system, and a specific portion of the vehicle 100.

The transceiver 112 may support mutual communication with a server, an Intelligent Transport System (ITS) device, surrounding vehicles, and the like. The transceiver 112 may include a module that processes, for example, cellular communication, wireless access in vehicular environment (WAVE) communication, dedicated short range communication (DSRC), and the like. In the present disclosure, the transceiver 112 may transmit data generated or stored during driving to the server and receive data and software modules transmitted from the server. The transceiver 112 may also support communication with an electronic device carried by the occupant inside the vehicle 100. In the present disclosure, the vehicle 100 may transmit and receive data utilized in a method according to the present disclosure with an external device through the transceiver 112.

For example, the transceiver 112 may receive traffic signal information from a traffic signal controller and provide the traffic signal information to the processor 130. In addition, the transceiver 112 may receive a control signal from the traffic signal controller and provide the control signal to the processor 130.

Additionally, the vehicle 100 may include the energy generating unit 110 and an actuating unit 116.

The energy generating unit 110 may generate and supply power and electric power used in a driving power system such as the actuating unit 116 and a non-driving power system. The non-driving power system may include, for example, the sensor unit 102, the operation unit 106, the display 108, the load device 114, and the transceiver 112, but is not limited thereto. The non-driving power system may include various components that implement sensing, an interface, communication, and convenience functions, excluding components directly involved in driving operations. When the vehicle 100 is driven based on electrical energy, the energy generating unit 110 may be implemented as, for example, an electric battery that is charged externally, or formed as a combination of an electric battery and a fuel cell that charges the battery. In the case of a combination of an electric battery and a fuel cell, the energy generating unit 110 may include a tank that stores a material used to produce electric power for the fuel cell, such as liquefied hydrogen. When the vehicle 100 is driven based on fossil fuel energy, the energy generating unit 110 may be implemented as an internal combustion engine. Additionally, when the vehicle 100 is a hybrid type, the energy generating unit 110 may be provided as a combination of an internal combustion engine and an electric battery.

The actuating unit 116 has at least one module that implements a driving operation and may perform at least one driving operation among longitudinal control such as acceleration/deceleration and lateral control such as steering, according to the user request from the operation unit 106. The actuating unit 116 may be equipped with a wheel driving unit 118, mechanical components for implementing a driving operation in the wheel driving unit 118, and electronic modules to perform the driving operation according to commands from the processor 130 by manual operation of the user or autonomous driving. When the vehicle 100 is operated based on electrical energy, the vehicle 100 may include an assembly for transmitting the requested driving operation to the wheel driving unit 118. When the vehicle 100 is operated based on fossil fuel energy, the actuating unit 116 may be equipped with a transmission and a gear module that transmits the power of the internal combustion engine.

The wheel driving unit 118 may include a plurality of wheels, a driving force generation module for generating a driving force and applying or transmitting the driving force to the wheels, a braking module for decelerating the driving of the wheels, and a steering module for implementing lateral control of the wheels. When the vehicle 100 is driven based on electrical energy, the driving force generation module may be implemented as a motor assembly that generates a driving force based on electric power output from the electric battery. The braking module of the electric-based vehicle 100 may further have a regenerative braking function.

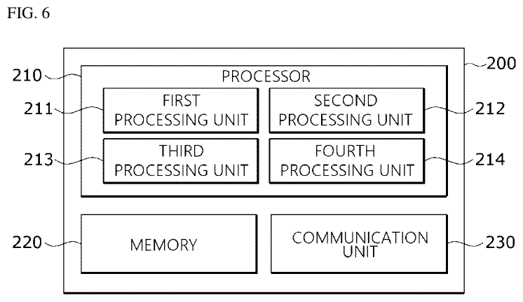

One of ordinary skill in the art should appreciate that one or more modules or units described herein may be implemented using, among other things, a tangible computer-readable medium or non-transitory memory, such as the memory 120 described with respect to FIG. 1 above or the memory 220 described in more detail below with respect to FIG. 6, comprising computer-executable instructions (e.g., executable software code) executed by specifically configured hardware or processors, e.g., the one or more processors 130 described with respect to FIG. 1 above or the processor 210 described in more detail below with respect to FIG. 6. It should be appreciated that the disclosed embodiments may be implemented as a different or separate modules or units of the vehicle 100, or a separate computer system coupled with the vehicle 100.

A navigation unit 122 may provide navigation information. The navigation information may include at least one of map information, set destination information, route information according to a set destination, information on various objects on the route, lane information, and current vehicle position information.

The navigation unit 122 may receive information from an external device through the transceiver 112 and update previously stored information. In some embodiments, the navigation unit 122 may be classified as a sub-component of the operation unit 106.

A sound output unit 124 may convert an electrical signal provided from the processor 130 into an audio signal and output an audio. For this purpose, the sound output unit 124 may include one or more speakers.

The processor 130 may control the operation of the speakers and generate the audio signal in conjunction with various systems in the vehicle 100. The processor 130 may adjust the sound output based on the vehicle speed, the ambient noise, and the traffic situations.

The processor 130 may be connected to a controller area network (CAN) bus system of the vehicle 100 and may transmit a sound signal to the speakers.

Additionally, the vehicle 100 may include a non-transitory memory 120 and the processor 130.

The memory 120 stores applications and various types of data for controlling the vehicle 100 and may load the applications or read or write data at the request of the processor 130.

The processor 130 may perform overall control of the vehicle 100. The processor 130 may be configured to execute the applications and instructions, e.g., the computer-executable instructions, stored in the memory 120.

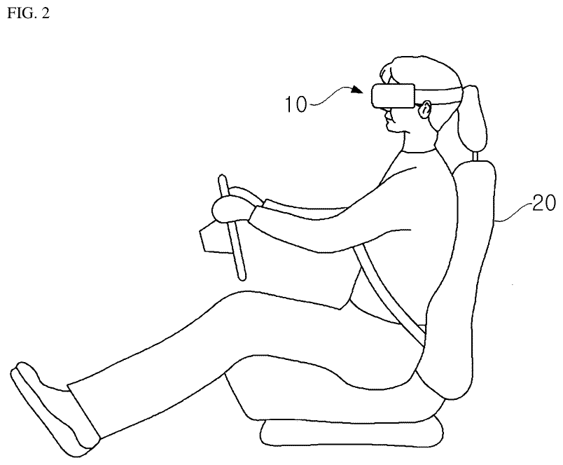

FIG. 2 is a diagram depicting the operating environment of a virtual environment content management apparatus according to an embodiment. A virtual environment content management apparatus 200 (see FIG. 6), according to an embodiment, may be applied to a user of an autonomous vehicle who experiences virtual environment content when the user wears a head-mounted display (HMD) 10 in a metaverse environment or the like, as shown in FIG. 2.

In an embodiment, the HMD 10 may be a display that is disposed inside the autonomous vehicle and worn on the head of the user. The HMD 10 may be used primarily in virtual reality (VR) and augmented reality (AR) applications and provide an immersive visual experience by placing a display in front of the user's eyes.

The HMD 10 may include a display panel that provides images to the user using two small screens or one large screen, and a lens positioned between the display and the user's eyes to adjust the images to the eyes.

The HMD 10 may adjust the field of view of the screen by tracking the head movement of the user using a head tracking technology implemented through a gyroscope, an accelerometer, a magnetic field sensor, and the like.

The HMD 10 may provide virtual environment content to the user who wears the HMD 10 and who may be seated in a seat 20. In the embodiment, the virtual environment content may include a virtual image and a virtual sound generated based on the driving environment of the vehicle driver.

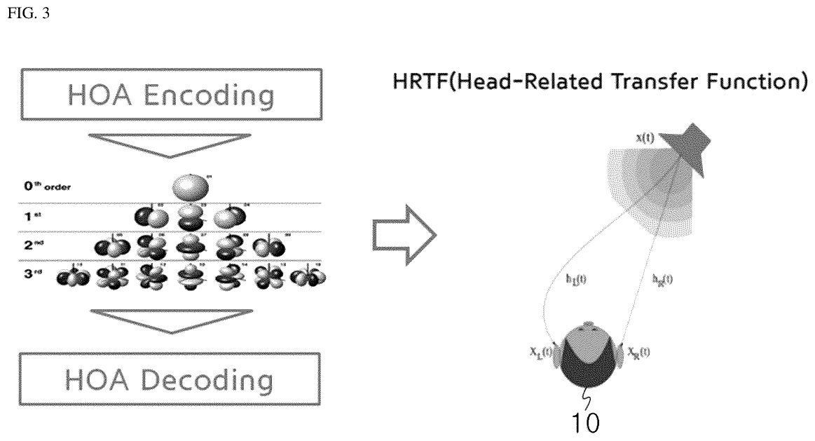

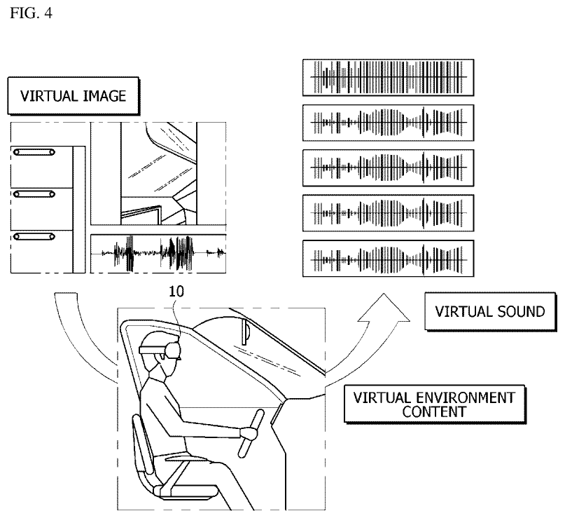

FIGS. 3 and 4 are diagrams depicting the virtual environment content according to an embodiment. Referring to FIGS. 3 and 4, the virtual image may refer to data obtained by visualizing an external background that the driver or passenger of the vehicle 100 may actually experience through a vehicle window while driving the vehicle 100. FIG. 3 further illustrates the implementation of high-order ambisonics (HOA) encoding and decoding for generating virtual sound within the virtual environment content. In this embodiment, HOA encoding involves converting sound source data, such as environmental noises or music, into a spherical harmonic representation that captures the three-dimensional spatial characteristics of the sound field. This encoded data is then processed by the virtual environment content management apparatus to integrate with the virtual image data. During HOA decoding, the apparatus reconstructs the three-dimensional sound field for output through speakers or a head-mounted display (HMD) worn by the occupant. The decoding process utilizes head-related transfer function (HRTF) logic, as described herein, to personalize the sound experience based on the occupant's head and ear characteristics, thereby enhancing immersion by aligning the virtual sound with the visualized external background depicted in FIG. 3.

Additionally, the virtual sound may include various noises and music that the driver or passenger of the vehicle may perceive inside the vehicle while driving the vehicle.

For example, the virtual sound may include high order ambisonics.

In an embodiment, the virtual environment content is made by applying the head-related transfer function (HRTF) logic of a three-dimensional sound implementation filter concept to a difference in sound perception based on the structure and shape of the head and ears, taking into account user personalization. Thus, it is possible to reduce dispersion of the virtual image and the virtual sound fidelity with the virtual environment content. High order ambisonics is a technique that may reproduce a three-dimensional sound by arranging speaker devices in a spherical shape centered on a listener, improve the sense of incongruity caused by inaccuracy in sound compared to the image, and implement a sound similar to reality.

The HRTF logic may change sound waves traveling toward a listener from a sound source located at a specific azimuth and elevation angle into sound waves with the characteristics necessary for directional perception due to the shape of the body, such as the shape of the head, the structure of the auricle, and the shape of the shoulder of each individual, which the sound waves pass through to reach the listener's ears. The HRTF logic may measure the characteristics that cause these changes and express the characteristics in the form of a transfer function. Since the shape of the body varies greatly from person to person, the HRTF is bound to vary for each person. Therefore, to utilize this accurately, a customized HRTF tailored to each individual user is required. However, to obtain HRTF data, measurements must be made at both a fixed azimuth and elevation. Currently, measuring HRTFs for all users is challenging because the equipment required to perform the measurement is complex and the measurement takes a long time. Therefore, in general, signal processing for producing binaural sound sources may be performed using the HRTF characteristics of a standard KEMAR dummy head or the characteristics in the open HRTF databases of experimenters provided from research institutes such as ARI, CIPIC, and IRCAM.

High order ambisonics is a technology for applying a panning technology, which adjusts the location of sound in a virtual space, beyond a sphere to the inside or outside of the sphere. A spherical wave may be expressed as a sum of spherical harmonic functions. Using this, sound waves may be reproduced by the spherical harmonic functions through each speaker. By adding these sound waves, it is possible to create sound waves identical to those output from a virtual sound source, which are desired by the user. Low order ambisonics, which uses a small number of spherical harmonic functions, does not create a large-scale sound field, but forms a sweet spot, which is a location where the user may accurately perceive the virtual sound field, in a very small area. To overcome this, high order ambisonics technology is applied. The minimum number of speakers required to implement n-th order ambisonics technology may be defined as (n+1)².

When the virtual environment content is executed, the user perceives the virtual image and virtual sound. The virtual environment content management apparatus according to an embodiment may analyze the correlation between image information and audio information through content analysis. The virtual environment content management apparatus 200 may output the audio information corresponding to the image information to minimize the sense of incongruity of the user experiencing the virtual environment content when the user is seated on the vehicle seat 20 and wears the HMD 10.

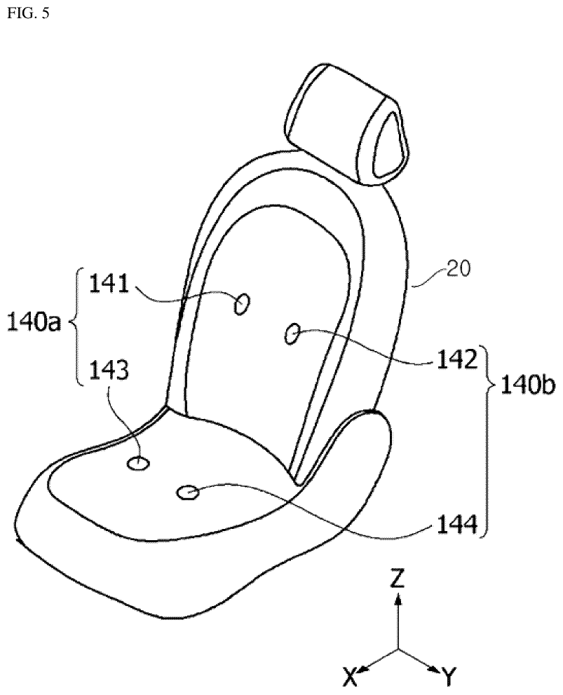

FIG. 5 is a diagram for describing the operation of vibrators according to an embodiment. Referring to FIG. 5, the seat 20 may include vibrators 140provided on a backrest and a seat bottom of the seat 20. The vibrators 140 may independently output a vibration signal. The vibrators 140 including vibrators 140a and 140b may be disposed to be embedded in empty spaces of the backrest and the seat bottom of the seat. Two vibrators 141 and 142 may be disposed on the backrest and two vibrators 143 and 144 may be disposed on the seat bottom, at a predetermined interval. The vibrators 141-144 may operate independently under the control of the processor 130 and output a predetermined vibration signal.

Each vibrator 140 may be implemented in a form including a frame forming an exterior, a voice coil that is installed inside the frame and forms a magnetic field when an electrical signal is applied, at least one magnet that vibrates at a certain frequency by interacting with the magnetic field of the voice coil, and a vibrating body that transmits the vibrations of the magnet to the human body. When an electrical signal is applied to the voice coil of the vibrator 140 under the control of the processor 130, a magnetic field proportional to the intensity of the electrical signal is formed in the voice coil. The magnetic field interacts with the magnet, causing the magnet to vibrate in an up-down direction at a predetermined frequency. When the vibration signal is output through the vibrating body and transmitted to the human body, the human body recognizes a predetermined acoustic signal.

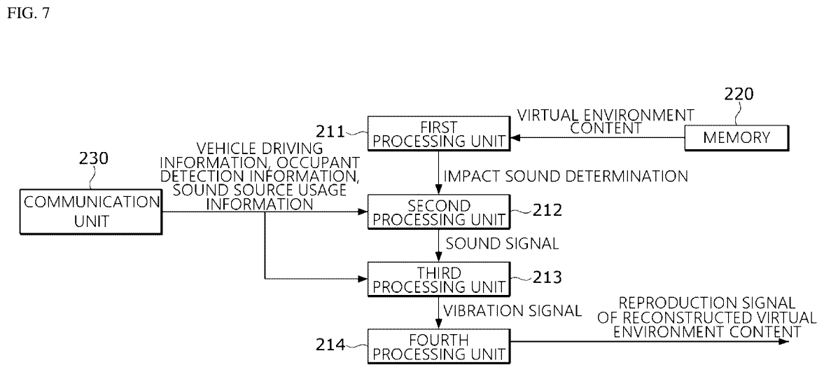

FIG. 6 is a block diagram of the virtual environment content management apparatus according to an embodiment. FIG. 7 is a diagram depicting the operation of the virtual environment content management apparatus according to an embodiment. Referring to FIGS. 6 and 7, the virtual environment content management apparatus 200 according to an embodiment may include a processor 210, a non-transitory memory 220, and a communication unit 230. The virtual environment content management apparatus 200 may be implemented inside the vehicle 100 and communicate with electronic components inside the vehicle 100.

The virtual environment content management apparatus 200 may communicate with the sensor units 102, 103, and 104 of FIG. 1 to transmit/receive data. The processor 210 and memory 220 of the virtual environment content management apparatus 200 may have the same configuration as the processor 130 and memory 120 illustrated in FIG. 1. Additionally, the communication unit 230 may have the same configuration as the transceiver 112 of FIG. 1.

The virtual environment content management apparatus 200 according to an embodiment may be implemented in a logic circuit by hardware, firmware, software, or a combination thereof, and may also be implemented using a specifically configured computer. The apparatus may be implemented using a hardwired device, a field programmable gate array (FPGA), an application specific integrated circuit (ASIC), and the like. Additionally, the apparatus may be implemented as a system on chip (SoC) including one or more processors 210 and a controller.

In addition, the apparatus 200 may be installed in a computing apparatus or server equipped with hardware elements in the form of software, hardware, or a combination thereof. The computing apparatus or server may refer to various apparatuses including all or some of a communication device such as a communication modem for communication with various devices or wired/wireless communication networks, the memory 220 for storing data for executing a program, and a microprocessor for executing the program to perform determination and instructions.

The memory 220 may include a database (DB). Additionally, the memory 220 may be a non-transitory storage medium that stores instructions executed by the processor 210. The memory 220 may include at least one of storage media such as a random access memory (RAM), a static random access memory (SRAM), a read only memory (ROM), a programmable ROM (PROM), an erasable PROM (EPROM), an electrically EPROM (EEPROM), a hard disk drive (HDD), a solid state disk (SSD), an embedded multimedia card (eMMC), an universal flash storage (UFS), and a web storage.

The memory 220 may store sound sources classified according to various types and genres, such as an entertainment type, a sandbox type, and a professional type.

The communication unit 230 may receive vehicle driving information and occupant detection information from the sensor unit of the vehicle and receive sound source usage information from a user terminal.

In an embodiment, the vehicle driving information may include vehicle altitude information, vehicle speed information, vehicle inclination information, vehicle weight information, vehicle direction information, vehicle battery information, vehicle fuel information, vehicle tire air pressure information, vehicle steering information, vehicle interior temperature information, vehicle interior humidity information, pedal position information, vehicle engine temperature information, and the like.

In an embodiment, the occupant detection information may include an audio signal generated by collecting voices and humming sounds expressed by the occupant, a vibration signal generated by measuring the vibrations occurring when the occupant taps the steering wheel, the console box, or the dashboard inside the vehicle, an occupant video signal generated by capturing images of the movements of the occupant, and a pressure signal generated by converting the pressure applied to the vehicle seat into an electrical signal.

In an embodiment, the sound source usage information may include metadata of a sound source reproduced on a terminal, metadata of a sound source tagged with a preference indication, and sound source reproduction information by period and time information.

In the present disclosure, the term “user” may be used interchangeably with the term “occupant” of a vehicle.

In an embodiment, the processor 210 includes a first processing unit 211, a second processing unit 212, a third processing unit 213, and a fourth processing unit 214. The first processing unit 211, the second processing unit 212, the third processing unit 213, and the fourth processing unit 214 may be implemented by the processor 210. For convenience of explanation, the operation of each component is described separately below.

The processor 210 may include at least one of processing devices such as an ASIC, a digital signal processor (DSP), a programmable logic device (PLD), an FPGA, a central processing unit (CPU), a microcontroller, and a microprocessor.

The first processing unit 211 may analyze the image information of the virtual environment content.

The first processing unit 211 may extract the image information from the virtual environment content using a convolutional neural network (CNN) and extract a temporal change in image information using a recurrent neural network (RNN).

The CNN of the first processing unit 211 may extract a feature map from the image information of the virtual environment content through an n-dimensional transformation filter (n is a natural number greater than or equal to 2) of the CNN.

For example, when learning one piece of 90×90 (pixels) of image data, the first processing unit 211 may apply multiple 3×3 convolution filters to generate various types of 30×30 feature map images. For example, in the case of n×n image data, when a 3×3 filter is used to create a 3×3 matrix (=convolution) and the largest value in the matrix is extracted as a representative value (=max pool), the dimensionality may be reduced. In a case in which multiple filters are used, the features of the image data of the object may be extracted to create a feature map. The first processing unit 211 may perform learning using the generated feature map.

The recurrent neural network of the first processing unit 211 may be a deep learning algorithm used to learn a pattern from time series data or sequential data. The recurrent neural network may process sequence data in which previous information affects the current state.

The first processing unit 211 may perform consistent prediction by causing a recurrent unit to transfer information from the previous state to the current state at each time step of the time series data and remember and utilize previous input information to reflect the previous input information in the current output.

In an embodiment, the first processing unit 211 may process the image information of the virtual environment content into each frame image using a CNN and then learn a temporal pattern between the frames using a recurrent neural network.

The second processing unit 212 may generate a sound signal using image information, sound source usage information, vehicle driving information, and occupant detection information.

The second processing unit 212 may set the sound signal as one of an entertainment type, a sandbox type, and a professional type using the sound source usage information. The second processing unit 212 may extract emotional adjectives using the sound source usage information and quantify the contribution of the emotional adjectives to set the sound signal as one of an entertainment type, a sandbox type, and a professional type.

The second processing unit 212 may extract emotional adjectives from music by utilizing frequently listened-to music data through an application on the user terminal and variabilize the emotional adjectives into three dimensions of an emotional response analysis model (PAD: pleasure, arousal, and dominance). The second processing unit 212 may classify the sound modeling of the virtual environment content in a customized manner according to preferred emotional characteristics of the user based on the analyzed data.

The second processing unit 212 may collect music, playlists, favorite songs, and the like, that the user frequently listens to by using sound source usage information received through the communication unit. The second processing unit 212 may analyze the metadata (for example, lyrics, title, genre, artist, and album information) for each song included in the sound source usage information, as well as lyrics that may be analyzed for text in the music, if available.

The second processing unit 212 may extract adjectives expressing the emotion of the music from the metadata of each sound source. For example, the second processing unit 212 may derive adjectives related to pleasure, arousal, and dominance using a music analysis algorithm or natural language processing (NLP) technology.

For example, the second processing unit 212 may derive adjectives expressing emotions such as happy, joyful, and sweet as pleasure-related adjectives.

For example, the second processing unit 212 may derive adjectives expressing emotions such as energetic, intense, and lively as arousal-related adjectives.

For example, the second processing unit 212 may derive adjectives expressing emotions such as confident, strong, and dominant as dominance-related adjectives.

The second processing unit 212 may map the derived emotional adjectives according to the three dimensions (pleasure, arousal, and dominance) of the PAD model.

For example, the second processing unit 212 may give a high score to ‘happy’ in the pleasure dimension, a high score to ‘energetic’ in the arousal dimension, and a high score to ‘dominant’ in the dominance dimension.

The second processing unit 212 may variabilize the scores in the range of 0-1 depending on the adjective. The second processing unit 212 may determine an average value of the emotional adjectives for each song and express the average value as the pleasure, arousal, and dominance (P, A, D) value for each song.

The second processing unit may generate an emotional profile of the user by averaging the (P, A, D) values of several songs preferred by the user. For example, if the average value for pleasure in the music that the user likes to listen to is high, the second processing unit 212 may interpret that the user prefers mainly pleasant emotions.

The second processing unit 212 may classify the sound signal into three sound modeling types according to the emotional preferences of the user derived from the PAD model.

For example, in a case in which the average value of pleasure is the highest, the second processing unit 212 may evaluate that the user prefers primarily positive and pleasant emotions. Accordingly, the second processing unit 212 may classify the sound signal as the entertainment type. The second processing unit 212 may enhance the user experience by adding a bright and cheerful sound track to the entertainment type sound signal stored in the memory 220.

For example, in a case in which the average value of arousal is the highest, the second processing unit 212 may evaluate that the user prefers music that is primarily energetic and stimulating. Accordingly, the second processing unit 212 may classify the sound signal as the sandbox type. The second processing unit may enhance user immersion by adding an intense and dynamic sound element to the sandbox type sound signal stored in the memory.

For example, in a case in which the average value of dominance is the highest, the second processing unit 212 may evaluate that the user prefers music that is confident and dominant. Accordingly, the second processing unit 212 may classify the sound signal as the professional type. The second processing unit 212 may add a calming yet focus-enhancing sound to the professional type sound signal stored in the memory 220.

The second processing unit 212 may set voice parameters corresponding to image parameters constituting the image information and generate a sound signal according to the voice parameters. The second processing unit 212 may extract image parameters including impact intensity, color, brightness, and contact time, and set the image parameters as voice parameters including volume, timbre, pitch, and duration.

The second processing unit 212 may analyze the image parameters constituting the image information and determine a first score, which is a quantitative index of each of the image parameters.

The second processing unit 212 may extract image parameters including impact intensity, color, brightness, and contact time from the image information. The second processing unit 212 may determine a first score for each image parameter through quantitative evaluation of each extracted image parameter.

The impact intensity may refer to the intensity of a specific event, background, movement, and the like within the image. For example, the impact intensity may refer to the intensity of an object at the moment the object falls or collides. The impact intensity may be used to evaluate the severity of the specific event, primarily by analyzing the magnitude, velocity change, and acceleration of the physical impact.

The color may refer to different colors that appear in the image. The color may be expressed as RGB (red, green, blue) values and may play an important role in identifying the mood, subject, and object of the image.

The brightness is a measure of the overall brightness of the image. The brightness may be obtained by measuring the amount of light in the image and may usually be determined as the average value of the brightness values of pixels.

The contact time is an index for measuring the time that two objects are in contact with each other in the image. For example, the contact time may refer to the time that a hand of a player is in contact with a ball in a sports game, or the time that vehicles are in contact with each other in a collision accident.

The second processing unit 212 may quantitatively evaluate the intensity of the image information to determine a first score for the impact intensity. The second processing unit 212 may determine the first score according to the degree of impact intensity evaluated from the image information. For example, the second processing unit 212 may determine the first score to be a larger value as the impact intensity is higher.

The second processing unit 212 may quantitatively evaluate the color sense of the image information and determine a first score for the color. The second processing unit 212 may determine the first score according to the degree of color sense evaluated from the image information. For example, the second processing unit 212 may determine the first score to be a larger value as the color sense is colder.

The second processing unit 212 may quantitatively evaluate the brightness of the image information to determine a first score for the brightness. The second processing unit 212 may determine the first score according to the degree of brightness evaluated from the image information. For example, the second processing unit 212 may determine the first score to be a larger value as the brightness value increases.

The second processing unit 212 may quantify the contact time and determine a first score for the contact time. The second processing unit 212 may determine the first score according to the duration for which the contact time evaluated from the image information is maintained. For example, the second processing unit 212 may determine the first score to be a larger value as the duration for which the contact time is maintained is longer.

The second processing unit 212 may set the voice parameters corresponding to the image parameters and use the first score to determine a second score, which is a quantitative index of each of the corresponding voice parameters.

The second processing unit 212 may set the volume, timbre, pitch, and duration as the voice parameters corresponding to the impact intensity, color, brightness and contact time. In other words, the second processing unit 212 may set the voice parameter corresponding to the impact intensity as volume, the voice parameter corresponding to the color as timbre, the voice parameter corresponding to the brightness as pitch, and the voice parameter corresponding to the contact time as duration.

A relationship called synaesthesia or synesthesia, in which the human brain perceives two or more of the five senses (sight, hearing, smell, taste, and touch) simultaneously, may be formed between an image element and an audio element. Synesthesia refers to a phenomenon in which a sensation caused by a certain stimulus simultaneously causes a sensation in another area. For example, a mutual influence between different aspects of the senses, such as hearing a sound due to an auditory stimulus and feeling a color at the same time or feeling a sound while seeing a color due to a visual stimulus, is called synesthesia. Synesthesia is applied when describing a certain type of emotion within another type of emotion, such as the relationship between color and sound, color and smell, or sound and smell.

The second processing unit 212 may set voice parameters that are determined to have a high correlation based on the relationship between images and sounds among these synesthetic relationships.

The volume is a measure of the size or intensity of the audio signal. The volume is determined by the amplitude of the sound and may express how loud or soft the sound is.

The timbre is the characteristic of a sound, allowing a person to distinguish a difference between different instruments or voices, even if the sounds have the same pitch and volume. The timbre may be determined by the shape of a frequency spectrum and the harmonic structure of a sound.

The pitch refers to how high or low a sound is and may be determined by frequency. The higher the frequency, the higher the pitch, and the lower the frequency, the lower the pitch.

The duration refers to the length of time during which the audio signal maintains a certain level of volume. The duration may refer to the time from the beginning to the end of a sound.

The second processing unit 212 may determine a second score of the volume in proportion to the first score of the impact intensity. The second processing unit 212 may determine the volume to be larger as the value of the first score of the impact intensity increases and determine the volume to be smaller as the value of the first score of the impact intensity decreases.

The second processing unit 212 may determine a second score of the timbre in proportion to the first score of the color. The second processing unit 212 may determine the second score such that the timbre becomes sharper as the value of the first score of the color increases and determine the second score such that the timbre becomes softer as the value of the first score of the impact intensity decreases.

The second processing unit 212 may determine a second score of the pitch in proportion to the first score of the brightness. The second processing unit 212 may determine the pitch to be higher as the value of the first score of the brightness increases and determine the pitch to be lower as the value of the first score of the brightness decreases.

The second processing unit 212 may determine a second score of the duration in proportion to the first score of the contact time. The second processing unit 212 may determine the duration to be longer as the value of the first score of the contact time increases and determine the duration to be shorter as the value of the first score of the contact time decreases.

The second processing unit 212 may generate a sound signal according to the generated voice parameters.

The second processing unit 212 may adjust volume, timbre, and sound spatial information of the sound signal using an accelerator pedal response and a vehicle speed. The second processing unit 212 may analyze the accelerator pedal response and vehicle speed data to generate a sound signal appropriate that matches the driving situation (low-speed start, acceleration, deceleration, cornering) of the vehicle 100. Additionally, the second processing unit 212 may implement the spatial movement of sound (forward/backward and left/right shift) into a sound signal depending on the acceleration situation.

The second processing unit 212 may determine the accelerator pedal response according to throttle position sensor data indicating a pedal pressure level (0% to 100%) using pedal position information included in the vehicle driving information. For example, the second processing unit 212 may determine the accelerator pedal response as 100% when the pedal is fully depressed and 0% when the pedal is not depressed at all.

In addition, the second processing unit 212 may analyze the rotational angular velocity and lateral acceleration of the vehicle 100 by utilizing the vehicle altitude information, vehicle speed information, vehicle inclination information, vehicle direction information, and vehicle steering information among the vehicle driving information, and detect whether the vehicle is cornering or driving in a straight line.

The second processing unit 212 may determine the driving situation of the vehicle to be the low-speed start situation when the accelerator pedal response is low and the vehicle speed gradually increases below a certain threshold value.

The second processing unit 212 may determine the driving situation of the vehicle to be the acceleration situation when the accelerator pedal response increases rapidly and the vehicle speed increases rapidly.

The second processing unit 212 may consider the driving situation of the vehicle as the deceleration situation when the vehicle speed decreases rapidly due to releasing the accelerator pedal or applying the brake.

The second processing unit 212 may determine the driving situation of the vehicle 100 to be a cornering situation when a high angular velocity or lateral acceleration (g-force) is detected while the vehicle 100 is turning.

The second processing unit 212 may reduce the volume of the sound signal and generate a sound signal that gives the feeling of a smooth start in the case of the low-speed start situation in which the accelerator pedal response and the vehicle speed are low.

The second processing unit 212 may generate a high-volume, dynamic, and intense sound signal in the acceleration situation.

The second processing unit 212 may generate a sound signal in which the feeling of the vehicle 100 stopping is enhanced by gradually lowering the volume in the deceleration situation.

The second processing unit 212 may generate a sound signal in which the cornering situation is enhanced by increasing the volume by a certain amount in the cornering situation.

Additionally, the second processing unit212 may generate a bass-heavy and soft sound signal in the low-speed start situation.

Additionally, the second processing unit 212 may generate a high-pitched sound signal (such as a turbocharger sound) by increasing the frequency in the acceleration situation.

Additionally, the second processing unit 212 may generate a calm sound signal using a mid-to-low range sound in the deceleration situation.

Additionally, the second processing unit 212 may generate a sound signal in which a friction sound of the vehicle body is emphasized by adding a metallic tone in the cornering situation.

Additionally, the second processing unit 212 may generate a sound signal that gives the effect that the sound is moving from the rear of the vehicle to the front thereof when the vehicle accelerates rapidly. The second processing unit 212 may be set to gradually move the sound to the front speakers by adjusting the sound pan and gain.

Additionally, the second processing unit 212 may generate a sound signal in which the effect of the sound moving from the front to the rear as the vehicle slows down is added in the deceleration situation.

Additionally, the second processing unit 212 may move a stereo image of the sound depending on a direction in which the vehicle 100 turns when cornering. For example, when the vehicle 100 turns left, the second processing unit 212 may move the sound to the left speaker. When the vehicle turns right, the second processing unit 212 may move the sound to the right speaker, to audibly emphasize the movement of the vehicle.

The third processing unit 213 may generate a vibration signal corresponding to the sound signal using the image information and the occupant detection information.

The third processing unit 213 may set a pattern of the vibration signal using a background sound and a sound effect of the sound signal. The third processing unit 213 may analyze the background sound and sound effect of the sound signal generated by the second processing unit 212 to optimize impact timing and control vibration feedback.

The third processing unit 213 may analyze the frequency spectrum of the sound signal using a fast Fourier transform (FFT) or short-time Fourier transform (STFT) algorithm. The third processing unit 213 may analyze the amplitude, frequency, and volume of the sound signal along a time axis to identify specific events (climax, impact).

The third processing unit 213 may detect the energy peak of the background sound or sound effect and select the climax timing. The third processing unit 213 may determine average energy within a given time window and define a section exceeding the average energy as the climax. For example, the third processing unit 213 may consider a chorus portion in a song or a point at which an intense sound effect occurs as the climax.

The third processing unit 213 may detect the moment when a short and intense sound effect (e.g., the sound of an explosion, an impact, etc.) occurs. For this purpose, a zero-crossing rate and a transient detection algorithm may be used to identify a point of rapid change.

The third processing unit 213 may divide the sound signal into a low frequency (20 to 250 Hz), a medium frequency (250 to 2000 Hz), and a high frequency (2000 to 20000 Hz) and analyze the energy in each frequency band. The third processing unit 213 may use the low-frequency band to generate vibrations mainly related to low-frequency bass and use the mid/high-frequency bands to emphasize sound effects and high-pitched sounds.

The third processing unit 213 may measure the intensity of the sound by tracking amplitude changes along the time axis. The third processing unit 213 may perform mapping such that higher amplitudes cause stronger vibrations.

The third processing unit 213 may extract the peak value of a sound waveform and set an initial impact and subsequent vibrations based on the peak value. The third processing unit 213 may control the intensity of vibration feedback by determining an energy distribution at the climax point.

The third processing unit 213 may generate a vibration signal corresponding to the background sound. For example, the third processing unit 213 may provide an initial impact vibration peak and then provide repeated vibrations. The third processing unit 213 may generate soft feedback using low-frequency vibrations that are in harmony with the rhythm of the background sound.

The third processing unit 213 may generate a vibration signal corresponding to the sound effect. For example, the third processing unit 213 may provide a maximum vibration peak at the initial climax and then transition to a gentle vibration.

The third processing unit 213 may analyze emotional information of the occupant using the occupant seating information included in the occupant detection information and set a pattern of the vibration signal according to the emotional information.

The third processing unit 213 may analyze a seating posture of the occupant through the pressure sensor built in the vehicle seat and collect a body pressure and sensitivity data to evaluate an emotional state of the occupant. The third processing unit 213 may generate a vibration pattern based on the analysis results.

The third processing unit 213 may use the pressure signal to analyze the maximum pressure value measured at a specific part (such as the buttocks or thigh) in the seat, an area over which the body pressure of the user is distributed across the entire seat, and the like, to check the balance of the seating posture of the occupant.

The third processing unit 213 may evaluate the center of pressure (CoP) by determining the center of gravity of the user, analyze a pressure change rate that occurs when the user changes his/her posture or moves, and analyze a difference in pressure distribution between the left and right thighs and buttocks to evaluate the asymmetry of posture.

The third processing unit 213 may analyze the emotional valence of the occupant based on the body pressure distribution and the maximum pressure value of the occupant.

For example, in a case in which the body pressure is evenly distributed and an appropriate pressure is applied to the back and thighs, the third processing unit 213 may consider that the user feels comfortable and thus analyzes the emotional information of the occupant as having high valence.

For example, in a case in which an excessive pressure is concentrated on a specific part or the occupant is leaning too deeply against the seat, the third processing unit 213 may analyze the emotional information of the occupant as having low valence.

The third processing unit 213 may evaluate an arousal level based on the movement change and pressure change rate of the occupant.

For example, the third processing unit 213 may determine that the arousal level of the occupant is high when the occupant frequently changes his/her posture or there is a rapid change in body pressure.

For example, the third processing unit 213 may determine that the arousal level of the occupant is low when the occupant maintains the same posture for a long period of time and there is little change in body pressure.

The third processing unit 213 may determine a vibration pattern according to the valence and arousal level.

For example, when it is determined that the emotional information of the occupant has high valence, the third processing unit 213 may provide a relaxation effect via continuous vibrations through a uniform vibration pattern.

For example, when it is determined that the arousal level of the occupant is low, the third processing unit 213 may provide vibrations with different intensities and time differences to the left/right and back/thigh parts in a crossing manner through pattern 2 (a cross vibration pattern). As a result, it is possible to draw the attention of the occupant by using the cross pattern vibration in a state of low emotional arousal.

The third processing unit 213 may analyze the action information of the image information to set a pattern of the vibration signal.

The third processing unit 213 may analyze the image information of the virtual environment content to set a vibration pattern of the vehicle seat 20 according to the action information in the image. The third processing unit 213 may detect an action (e.g., flight, acceleration, collision, cornering, etc.) in the image information in real time and apply a corresponding vibration feedback signal to the vehicle seat 20 to maximize the immersion of the occupant.

The third processing unit 213 may extract key features from each frame of the image information using a computer vision algorithm. The third processing unit 213 may detect major objects such as vehicles, obstacles, and roads and identify changes in speed and direction of objects using motion analysis: optical flow and deep learning-based models (CNN, RNN). Additionally, a collision situation (e.g., a vehicle collision, sudden stop) may be identified in the image information.

The third processing unit 213 may analyze a difference between the frames of the image information to check a point at which an event occurs. For example, the third processing unit 213 may analyze an increase in forward movement speed of a screen when the vehicle 100 accelerates, or an increase in left-right shaking when the vehicle 100 slips.

The third processing unit 213 may classify action events in the image information based on the analyzed information.

The third processing unit 213 may evaluate the excitement and tension that the occupant may feel according to the action event through emotion analysis. The third processing unit 213 may quantify the emotional intensity of each action event using an arousal-valence model.

For example, the third processing unit 213 may perform emotion analysis to determine that the occupant has high arousal and medium valence when an object accelerates in the image information. The third processing unit 213 may generate a vibration signal in a vibration pattern with the same intensity at a constant cycle (e.g., 15 Hz). The third processing unit 213 may set rapid and repetitive vibrations to simulate the feeling of stepping on a pedal.

For example, the third processing unit 213 may perform emotion analysis to determine that the occupant has high arousal and high valence when an object flies in the image information. The third processing unit 213 may generate a vibration signal using a vibration pattern of starting with a soft vibration initially and gradually increasing vibration intensity as the speed increases. The third processing unit 213 may increase the frequency from a low frequency to a high frequency to provide a vibration similar to an engine sound.

For example, the third processing unit 213 may perform emotion analysis to determine that the occupant has high arousal and low valence when an object collides in the image information. At this time, the third processing unit 213 may provide directional vibration by setting a time delay on the left and right seats according to a collision side. For example, a vibration pattern may be set such that a vibration is first provided to the vibrator of the seat adjacent to the collision side, and then after a delay of 0.3 seconds, the vibrator of the seat adjacent to a side opposite to the collision side vibrates.

The third processing unit 213 may set the vibration intensity from 0% to 100% depending on the intensity of the action event.

The fourth processing unit 214 may reconstruct the virtual environment content using the sound signal and the vibration signal. The fourth processing unit 214 may generate a reproduction signal obtained by synchronizing the sound signal and the vibration signal with the image information of the virtual environment content.

The fourth processing unit 214 may perform control such that the HMD 10 reproduces the image information and the sound signal and the vibrator of the seat outputs the vibrations according to the vibration signal using the synchronized reproduction signal.

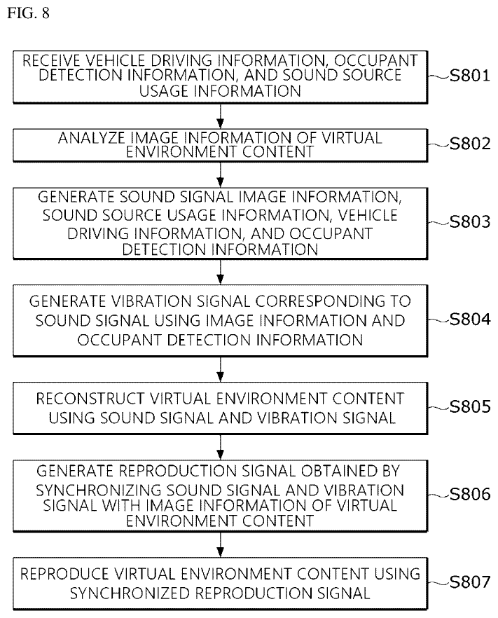

FIG. 8 is a flowchart of a virtual environment content management method according to an embodiment.

Referring to FIG. 8, the communication unit receives vehicle driving information and occupant detection information from the sensor unit of the vehicle and receives sound source usage information from a user terminal (S801).

Next, the processor analyzes the image information of the virtual environment content (S802).

Next, the processor generates a sound signal using the image information, the sound source usage information, the vehicle driving information, and the occupant detection information (S803). For example, the processor extracts emotional adjectives using the sound source usage information and quantifies the contribution of the emotional adjectives to set the sound signal as one of the entertainment type, the sandbox type, and the professional type. For example, the processor sets voice parameters corresponding to image parameters constituting the image information and generates a sound signal according to the voice parameters. For example, the processor adjusts the volume, timbre, and sound spatial information of the sound signal using an accelerator pedal response and a vehicle speed.

Next, the processor generates a vibration signal corresponding to the sound signal using the image information and the occupant detection information (S804). For example, the processor sets a pattern of the vibration signal using the background sound and sound effect of the sound signal. For example, the processor analyzes emotional information of the occupant using seating information of the occupant included in the occupant detection information and sets a pattern of the vibration signal according to the emotional information. For example, the processor analyzes action information of the image information to set a pattern of the vibration signal.

Next, the processor reconstructs the virtual environment content using the sound signal and the vibration signal (S805).

Next, the processor generates a reproduction signal obtained by synchronizing the sound signal and the vibration signal with the image information of the virtual environment content (S806).

Next, the processor performs control such that the HMD reproduces the image information and the sound signal and the vibrator of the seat outputs the vibration according to the vibration signal using the synchronized reproduction signal (S807).

As noted above, the term “unit” used in the present embodiment refers to software or hardware component(s) such as a field-programmable gate array (FPGA) or an ASIC, and the “unit” performs certain roles. However, the “unit” is not limited to software or hardware. The “unit” may reside on an addressable storage medium and configured to reproduce one or more processors. Therefore, for example, the “unit” includes components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into a smaller number of components and “unit” or separated into additional components and “units.” Additionally, the components and “units” may be implemented to reproduce one or more CPUs in a device or a security multimedia card.

The virtual environment content management apparatus and method according to various embodiments can generate or adjust sounds and vibrations to match an image of virtual environment content.

In addition, as a result, it is possible to improve the immersion experience of a vehicle occupant in a virtual environment.

Although the present disclosure has been described above with reference to various embodiments, those of ordinary skill in the art should understand that the present disclosure may be modified and changed in various ways without departing from the spirit and scope of the present disclosure as described in the appended claims.

What is claimed is:

1. A virtual environment content management apparatus comprising:
a communication unit configured to receive vehicle driving information and occupant detection information from a sensor unit of a vehicle and receive sound source usage information from a user terminal;
a non-transitory memory configured to store computer-executable instructions; and
one or more processors coupled with the non-transitory memory, the one or more processors configured to execute the computer-executable instructions to implement
a first processing unit configured to analyze image information of virtual environment content,
a second processing unit configured to generate a sound signal based on the image information, the sound source usage information, the vehicle driving information, and the occupant detection information,
a third processing unit configured to generate a vibration signal corresponding to the sound signal based on the image information and the occupant detection information, and
a fourth processing unit configured to reconstruct the virtual environment content based on the sound signal and the vibration signal.

2. The virtual environment content management apparatus of claim 1, wherein the second processing unit is configured to set the sound signal as one of an entertainment type, a sandbox type, and a professional type based on the sound source usage information.

3. The virtual environment content management apparatus of claim 2, wherein the second processing unit is configured to extract emotional adjectives based on the sound source usage information and quantify contribution of the emotional adjectives to set the sound signal as one of an entertainment type, a sandbox type, and a professional type.

4. The virtual environment content management apparatus of claim 1, wherein the second processing unit is configured to set voice parameters corresponding to image parameters constituting the image information and generate the sound signal based on the voice parameters.

5. The virtual environment content management apparatus of claim 4, wherein the second processing unit is configured to extract the image parameters including impact intensity, color, brightness, and contact time, and set the image parameters to the voice parameters including volume, timbre, pitch, and duration.

6. The virtual environment content management apparatus of claim 1, wherein the second processing unit is configured to adjust volume, timbre, and sound spatial information of the sound signal based on an accelerator pedal response and a vehicle speed.

7. The virtual environment content management apparatus of claim 1, wherein the third processing unit is configured to set a pattern of the vibration signal based on a background sound and a sound effect of the sound signal.

8. The virtual environment content management apparatus of claim 1, wherein the third processing unit is configured to analyze emotional information of an occupant based on seating information of the occupant included in the occupant detection information and set a pattern of the vibration signal based on the emotional information.

9. The virtual environment content management apparatus of claim 1, wherein the third processing unit is configured to analyze action information of the image information to set a pattern of the vibration signal.

10. The virtual environment content management apparatus of claim 1, wherein the fourth processing unit is configured to generate a reproduction signal obtained by synchronizing the sound signal and the vibration signal with the image information of the virtual environment content.

11. A virtual environment content management method comprising:
receiving, by a communication unit, vehicle driving information and occupant detection information from a sensor unit of a vehicle and sound source usage information from a user terminal;
analyzing, by a processor, image information of virtual environment content;
generating, by the processor, a sound signal based on the image information, the sound source usage information, the vehicle driving information, and the occupant detection information;
generating, by the processor, a vibration signal corresponding to the sound signal based on the image information and the occupant detection information; and
reconstructing, by the processor, the virtual environment content based on the sound signal and the vibration signal.

12. The virtual environment content management method of claim 11, wherein the generating of the sound signal includes setting, by the processor, the sound signal as one of an entertainment type, a sandbox type, and a professional type based on the sound source usage information.

13. The virtual environment content management method of claim 12, wherein the generating of the sound signal includes:
extracting, by the processor, emotional adjectives based on the sound source usage information; and
quantifying, by the processor, contribution of the emotional adjectives to set the sound signal as one of an entertainment type, a sandbox type, and a professional type.

14. The virtual environment content management method of claim 11, wherein the generating of the sound signal includes:
setting, by the processor, voice parameters corresponding to image parameters constituting the image information; and
generating, by the processor, the sound signal based on the voice parameters.

15. The virtual environment content management method of claim 14, wherein the generating of the sound signal includes:
extracting, by the processor, the image parameters including impact intensity, color, brightness, and contact time; and
setting, by the processor, the image parameters to the voice parameters including volume, timbre, pitch, and duration.

16. The virtual environment content management method of claim 11, wherein the generating of the sound signal includes adjusting, by the processor, volume, timbre, and sound spatial information of the sound signal based on an accelerator pedal response and a vehicle speed.

17. The virtual environment content management method of claim 11, wherein the generating of the sound signal includes setting, by the processor, a pattern of the vibration signal based on a background sound and a sound effect of the sound signal.

18. The virtual environment content management method of claim 11, wherein the generating of the sound signal includes:
analyzing, by the processor, emotional information of an occupant based on seating information of the occupant included in the occupant detection information; and
setting, by the processor, a pattern of the vibration signal based on emotional information.

19. The virtual environment content management method of claim 11, wherein the generating of the sound signal includes analyzing, by the processor, action information of the image information to set a pattern of the vibration signal.

20. The virtual environment content management method of claim 11, wherein the reconstructing of the virtual environment content includes generating, by the processor, a reproduction signal obtained by synchronizing the sound signal and the vibration signal with the image information of the virtual environment content.
